(19) United States
(12) Patent Application Publication
(10) Pub. No.: US 2012/0235627 A1
(43) Pub. Date: Sep. 20, 2012

(54) BALANCING ELECTRICAL VOLTAGES OF GROUPS OF ELECTRICAL ACCUMULATOR UNITS

(76) Inventors: Stefan Butzmann, Beilstein (DE); Holger Fink, Stuttgart (DE)

(21) Appl. No.: 13/509,149

(22) PCT Filed: Nov. 19, 2009
(86) PCT No.: PCT/EP2009/065477

§ 371 Date: Jun. 5, 2012

(51) Int. Cl. H02J 7/00

(52) U.S. Cl. 320/103

(57) ABSTRACT

A method for balancing the electrical group voltages of at least two accumulator groups which are connected in series and each of which have a plurality of accumulator units provides that one accumulator group is connected to the winding of a coil in order to excite the coil, and the other accumulator group is charged by the excited coil by the subsequent connection of the winding to the other accumulator group. In addition, a corresponding electrical accumulator is provided.

The invention relates to a method for balancing the electrical group voltages of at least two serially connected accumulator groups, each having a plurality of accumulator units. The invention also relates to a corresponding electrical accumulator.

### PRIOR ART

It is clear that in future, in both stationary applications, such as wind farms and non- stationary applications, such as in vehicles, for example hybrid and electric vehicles, new battery systems of which very stringent demands for reliability will be made will increasingly come into use. The background of these demands is that a failure of the battery systems can lead to either a failure of an entire system pertaining to the application, or to a safety-relevant problem. One conceivable example of such a failure is an electric vehicle that if its traction battery fails is “dead in the water”, since it is no longer capable of propelling itself. As an example of a safety-relevant problem, a wind farm is conceivable, in which electrical accumulators are used for protecting the farm against impermissible modes of operation by adjusting the rotor blades under strong wind conditions. Failure of these electrical accumulators can then lead to safety-relevant problems.

When many individual accumulator units, such as battery cells, connected in series are used, the individual accumulator units are not automatically equal. As a result, particularly over the service life of the accumulator units, this leads to unequal electrical voltages among the individual accumulator units, unless appropriate countermeasures are taken. Especially with lithium-ion batteries, excessive charging or deep discharging of individual accumulator units leads to irreversible damage. Such excessive charging or deep discharging can result when a battery management system regulates a charging or discharging operation based on one of the accumulator units, which is not representative all of the accumulator units. For that reason, balancing of the electrical voltages of the electrical accumulator units among one another must be done at regular intervals. This balancing is known as “cell balancing”. To that end, the individual accumulator units are discharged, by external wiring provisions, in such a way that after the balancing, they all have the same electrical voltage.

It is known for that purpose to perform so-called resistance balancing. To that end, an ohmic resistor or a resistor combination is assigned to each accumulator unit via switches. By means of the resistors, the accumulator units are discharged until such time as the accumulator units have the electrical voltage. It is disadvantageous here that energy stored in the electrical accumulator units is converted into heat by the resistors and is carried away unused, for the sake of achieving the desired charge balance. Hence there is a need for a way in which balancing the electrical voltages of a plurality of accumulator units among one another is attained with little energy loss and in which a substantial improvement in the efficiency of a complete electrical accumulator system is brought about.

### SUMMARY OF THE INVENTION

According to the invention, it is provided that one accumulator group is connected to the winding of a coil or its excitation, and that after that, by means of the excited coil, by connection of the winding to the other accumulator group, the latter is charged. It is provided that the winding of one coil be connected to one of the accumulator groups, and after that, that the same winding of the same coil be connected to another of the accumulator groups. In this way, it becomes possible for the energy stored in the accumulator groups not to be merely converted into heat, but to be transferred from the one accumulator group to the other, so that the electrical voltages of the various accumulator groups are balanced with each other. The accumulator groups connected in series have accumulator units, which are preferably likewise connected in series. This is understood to mean that each positive pole of an accumulator unit is connected directly to a negative pole of a following accumulator unit via a line. This applies accordingly to connections between the accumulator groups as well. Charging the other accumulator group should be understood to mean that the coil is excited, and by means of the electrical energy that is thus available, the other accumulator group is further charged. Charging should accordingly be understood to mean not full charging of the entire electrical accumulator, but rather transporting an electrical charge between the accumulator groups and the winding for the sake of balancing the electrical voltages.

In a further feature of the invention, it is provided that at least one of the accumulator units is discharged via an electrical consumer, in particular an ohmic resistor, for individual voltage balancing.

In a further feature of the invention, it is provided that the accumulator group having the highest group voltage is connected to the winding of the coil for its excitation.

In a further feature of the invention, it is provided that the accumulator unit having the highest electrical voltage within its accumulator group is discharged via the electrical consumer for individual voltage balancing.

In a further feature of the invention, it is provided that as the accumulator units, one accumulator cell each, in particular a battery cell, is used.

In a further feature of the invention, it is provided that the winding is connected to the accumulator group for excitation of the coil by means of closure of at least one switch. Using the switch makes it possible to excite at least one coil in a targeted manner, or in other words to connect the winding. In this way, the method can be employed in a targeted manner to individual accumulator groups, without always having to include all the accumulator groups in the method.

In a further feature of the invention, it is provided that the winding is connected to the other accumulator group by opening the switch. By appropriate interconnection, it becomes possible to end the exciting of the coil by opening the switch, and by reinduction, or in other words de-excitation, the coil makes the energy stored in it available. In that case, the coil tries to output the stored electrical energy, and that energy is taken up by the other accumulator group that is to be being charged. The combination here of closing the switch to excite the coil and opening the switch to charge the accumulator group is advantageous, since by means of only two positions of the switch, both the excitation and the charging of the accumulator group can be brought about in succession in a simple way.

In a further feature of the invention, it is provided that the other accumulator group is charged by the coil via at least one diode. This is especially advantageous whenever a flow of current, which flows into the winding upon excitation of the coil, is reversed and flows out of the winding again, for charging the accumulator group in the reverse manner. Thus the winding can be connected automatically to the appropriate associated accumulator group, depending on whether the coil is excited or is being discharged.

In a further feature of the invention, it is provided that a plurality of charged accumulator groups and a plurality of switches are used, and that the excited coil, by means of an opening of at least one switch, charges at least one associated accumulator group. The association of switches with individual accumulator groups makes it possible in a simple way in terms of circuitry, beginning with one accumulator group, to balance that accumulator group with a plurality of other accumulator groups. This can be done in particular in the form of a chain, so that two accumulator groups, one at the beginning and one at the end of the chain, can each charge only one adjacent accumulator group via one coil, and all the other accumulator groups can each selectively charge one or two adjacent accumulator groups.

The invention relates further to an electrical accumulator having at least two serially connected electrical accumulator groups, each with a plurality of accumulator units, and having an electrical balancing circuit, in particular for performing the method described above, in which the balancing circuit has at least one coil having a winding, the winding of which is connectable to one of the accumulator groups for excitation of the coil, and for charging the other accumulator group, the winding is connectable to that accumulator group.

In a further feature of the invention, it is provided that the balancing circuit has at least one diode and/or at least one switch.

In a further feature of the invention, it is provided that the switch is embodied as a semiconductor switch, in particular a transistor, thyristor, or the like. By the use of semiconductor elements, very easy automation is made possible, by means of electrical components, such as circuits. Moreover, in this way the device of the invention can be embodied in a space-saving way and can be produced economically.

In a further feature of the invention, it is provided that the balancing circuit has at least one ohmic resistor for discharging at least one of the accumulator units.

In a further feature of the invention, it is provided that each of the accumulator units has an accumulator cell, in particular a battery cell.

The drawings illustrate the invention in terms of an exemplary embodiment; in the drawings:

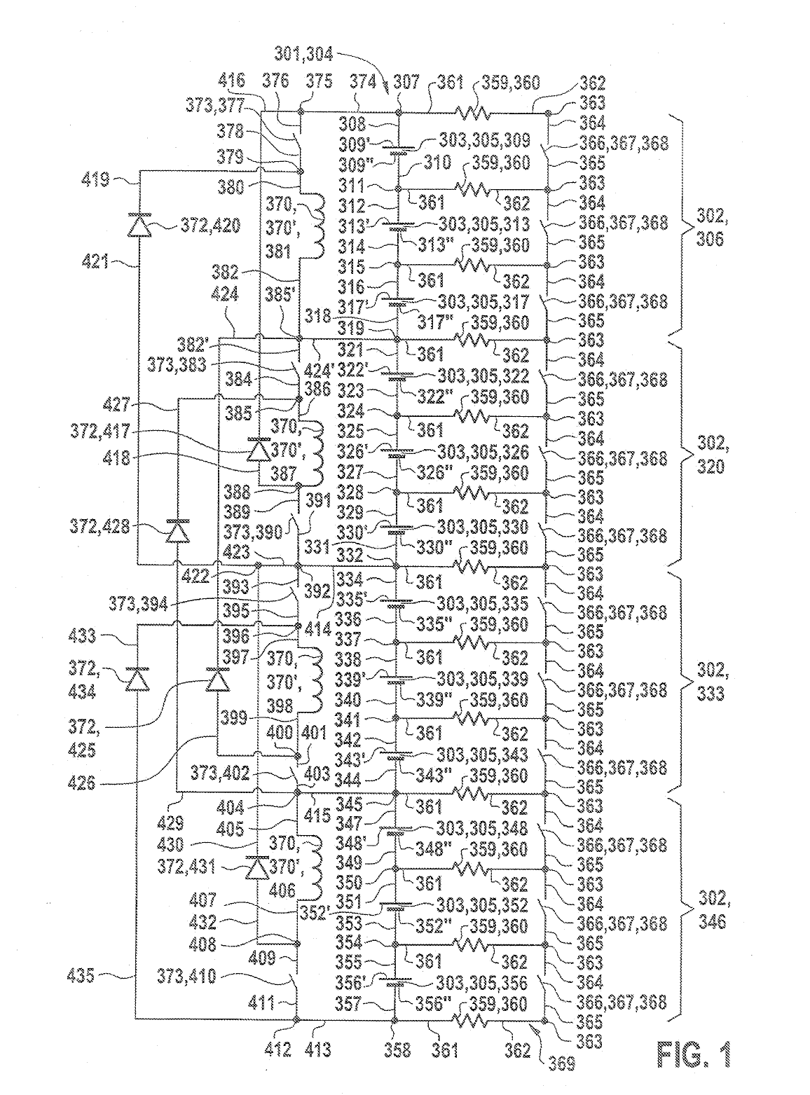

FIG. 1 shows an electric switch with a balancing circuit;

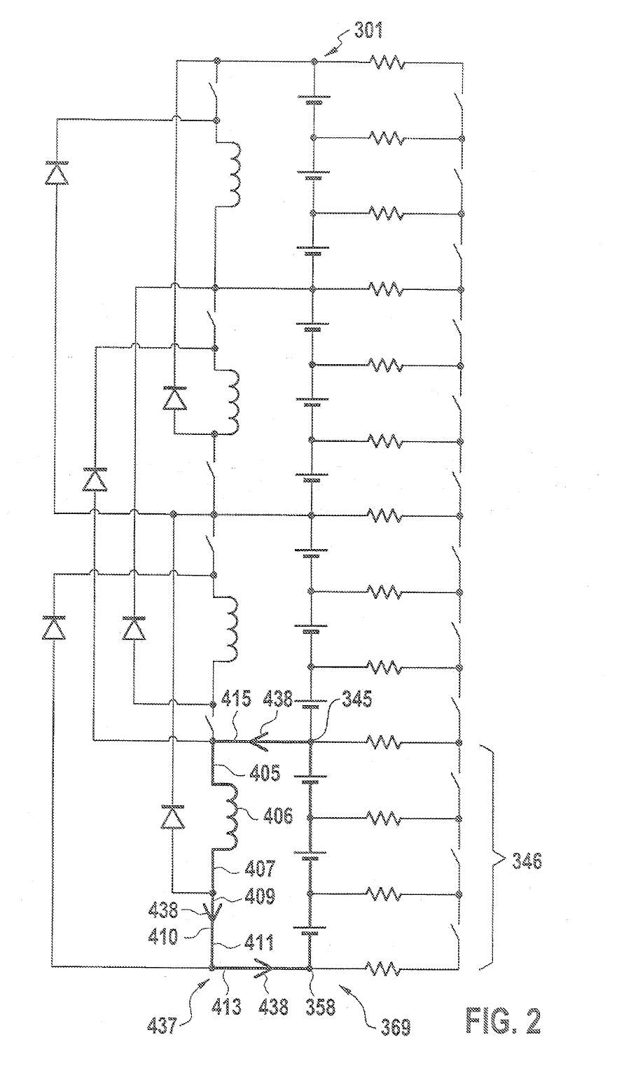

FIG. 2 shows the accumulator with the balancing circuit of FIG. 1 in a first method step;

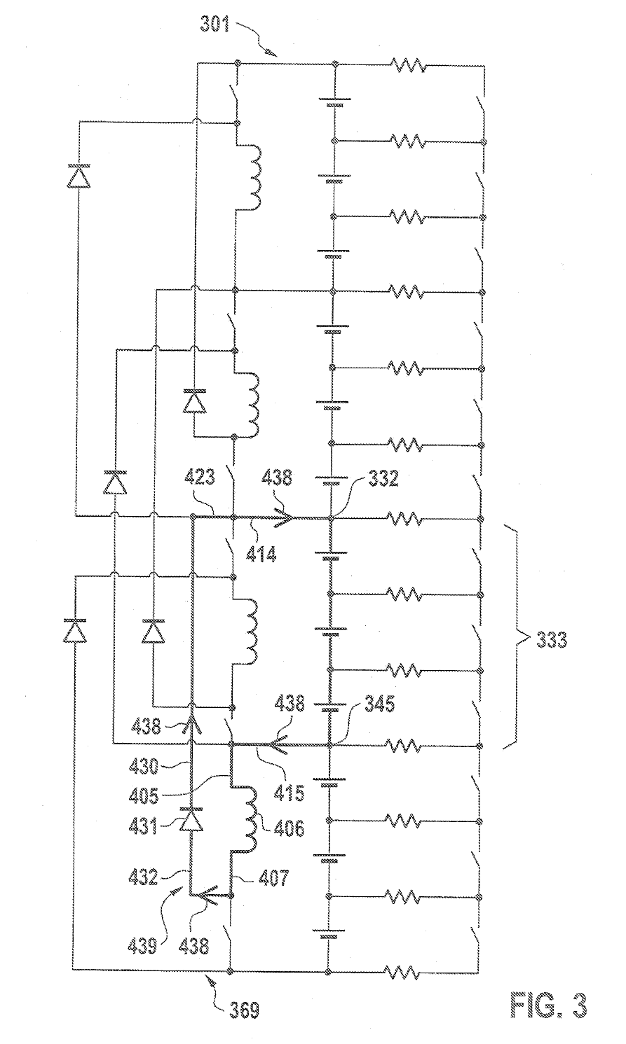

FIG. 3 shows the accumulator with the balancing circuit of FIG. 1 in a second method step;

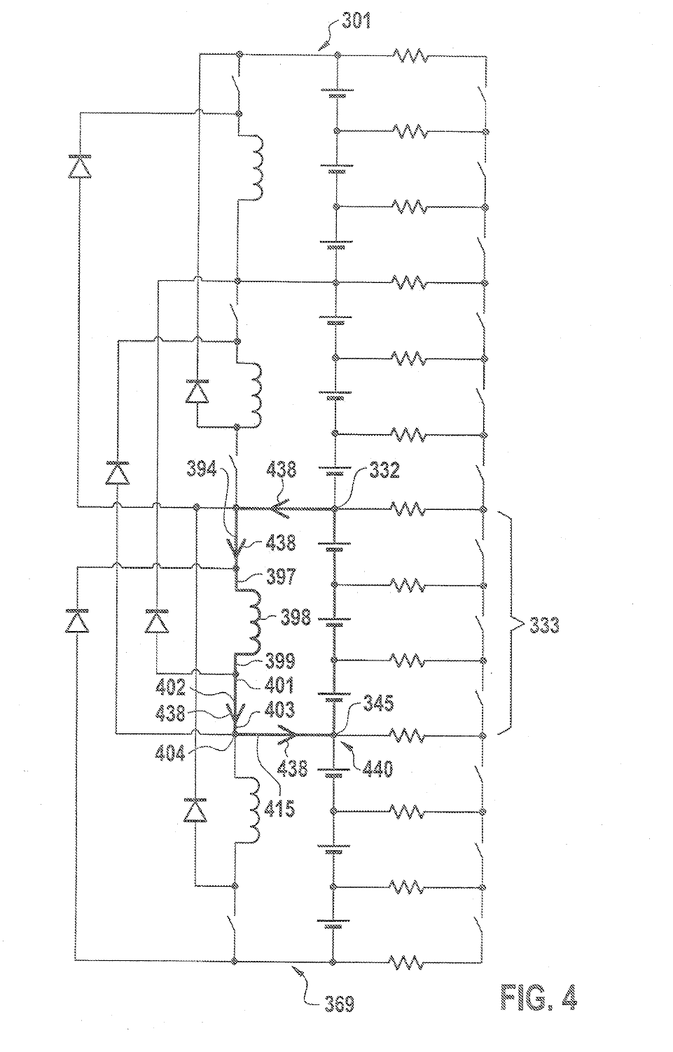

FIG. 4 shows the accumulator with the balancing circuit of FIG. 1 in a further, first method step;

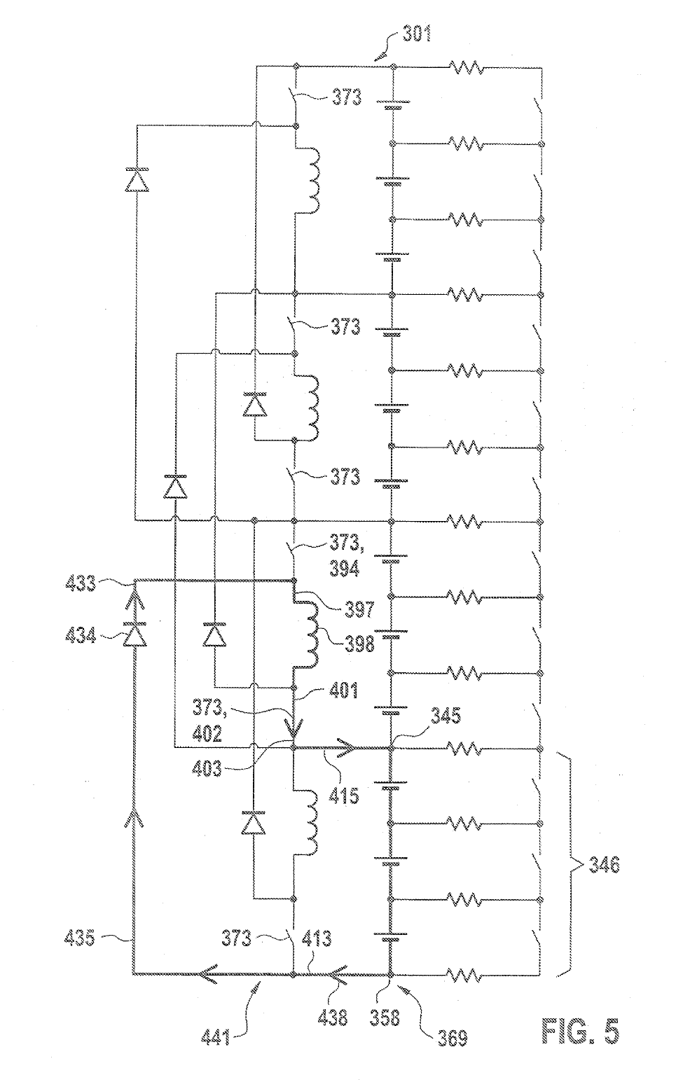

FIG. 5 shows the accumulator with the balancing circuit of FIG. 1 in a further, second method step; and

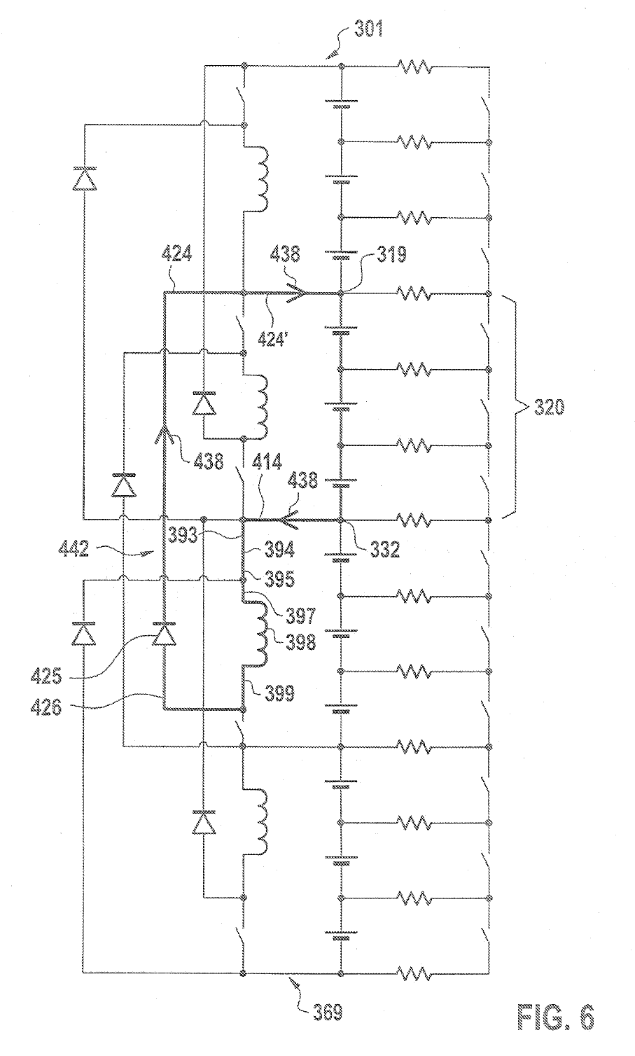

FIG. 6 shows the accumulator with the balancing circuit in a further, second method step.

FIG. 1 shows an electrical accumulator 301, which comprises a plurality of adjacent accumulator groups 302. Each of the accumulator groups 302 has accumulator units 303, which are connected in series to one another and thus form the accumulator groups 302. The accumulator 301 is embodied as a battery 304, and the accumulator units 303 are embodied as accumulator cells in the form of battery cells. A first accumulator group 306 has a node point 307, which is connected via a line 308 to a positive pole 309′ of a first accumulator unit 309. From a negative pole 309″ of the first accumulator unit 309, a further line 310 extends to a node point 311. The node point 311 is connected via a line 312 to a positive pole 313′ of a second accumulator unit 313, which in turn is connected via a negative pole 313″ and a line 314 to a node point 315. The node point 315 is connected via a line 316 to a positive pole 317′ of a third accumulator unit 317, which is connected via a negative pole 317″ and via a line 318 to a node point 319. The node point 319 simultaneously forms the termination of the first accumulator group 306 and the beginning of a second accumulator group 320. The second accumulator group 320 begins at the node point 319 and extends via a line 321 to a positive pole 322′ of a fourth accumulator unit 322, which is connected via a negative pole 322″ and a line 323 to a node point 324. From the node point 324, a line 325 extends to a positive pole 326′ of a fifth accumulator unit 326, which is connected via a negative pole 326″ and a line 327 to a node point 328. From the node point 328, a line 329 extends to a positive pole 330′ of a sixth accumulator unit 330, which is connected via a negative pole 330″ and a line 331 to a node point 332. At the node point 332, the second accumulator group 320 ends and a third accumulator group 333 begins. Beginning at the node point 332, the third accumulator group 333 contains a line 334, which extends to a positive pole 335′ of a seventh accumulator unit 335, which in turn is connected via a negative pole 335″ and a line 336 to a node point 337. From the node point 337, a further line 338 extends to a positive pole 339′ of an eighth accumulator unit 339, which is connected via a negative pole 339″ and a line 340 to a node point 341. From the node point 341, a line 342 extends to a positive pole 343′ of a ninth accumulator unit 343, which is connected via a negative pole 343″ and a line 344 to a node point 345, which forms a termination of the third accumulator group 333. Simultaneously, the node point 345 forms a beginning of a fourth accumulator group 346. From the node point 345, a line 347 extends to the positive pole 348′ of a tenth accumulator unit 348, which is connected via a negative pole 348″ and a line 349 to a node point 350. From the node point 350, a line 351 extends to a positive pole 352′ of an eleventh accumulator unit 352, which is connected via a negative pole 352″ and a line 353 to a node point 354. The node point 354 is connected in turn via a line 355 to a positive pole 356′ of a twelfth accumulator unit 356. The accumulator unit 356 is connected via a negative pole 356″ and a line 357 to a node point 358, which terminates the fourth accumulator group 346. Each of the accumulator units 303 is assigned electrical consumers 359, which are embodied as ohmic resistors 360. One electrical consumer 359 is connected to each node point of the electrical accumulator 301 by means of a line 361. From each electrical consumer 359, a respective line 361 extends to node points 363. Between each two node points 363 located side by side, one line 364 and a line 365 separate from it are disposed, which are connectable via a switch 366 in the form of a semiconductor switch 367, which is a transistor 368. By means of the connection of the lines 364 and 365, two node points 363 each are connected to one another. The electrical consumers 359 and the associated switches 366 are all part of a balancing circuit 369. The balancing circuit 369 additionally has windings 370 of electrical coils 370′. The balancing circuit 369 also has diodes 372 and switches 373. From the node point 307, a further line 374 leads to the node point 375, which is connected via a line 376 to a first switch 377. The switch 377 is connected via a line 378 to a further node point 379. The node point 379 is additionally connected via a line 380 to a first winding 381, which is also connected via a line 382 to a node point 385′. The node point 385′ is connected via a line 382′ to a second switch 383. The second switch 383 is connected via a line 384 to a node point 385, which leads via a line 386 to a second winding 387. The second winding 387 has a further node point 388, which is connected via a line 389 to a third switch 390. The third switch 390 is additionally connected via a line 391 to a node point 392. From the node point 392, a line 393 extends to a fourth switch 394, which is connected via a line 395 to a node point 396. The node point 396 is connected in turn, via an additional line 397, to a third winding 398. From the third winding 398, a further line 399 extends to a node point 400. The node point 400 is connected via a line 401 to a fifth switch 402, which leads via a line 403 to a node point 404. From the node point 404, a line 405 leads to a fourth winding 406, which merges with a line 407 and is connected to a node point 408. The node point 408 is connected via a line 409 to a sixth switch 410. That switch is connected via a further line 411 to a node point 412, which in turn is connected via a line 413 to the node point 358. A further line 414, which connects the node points 392 and 323 to one another, extends from the node point 392. The node points 404 and 345 are also connected to one another via a line 415. From the node point 375, a further line 416 extends to a first diode 417, which is connected via a line 418 to the node point 388. The diode 417 is disposed with a flow direction from the line 418 to the line 416. Beginning at the node point 379, a line 419 is connected to a second diode 420, which is connected via a further line 421 to a node point 422. The node point 422 is connected via an additional line 423 to the node point 392. The second diode 420 is disposed such that its flow direction extends from the line 421 to the line 419. From the node point 319, a further line 424′ extends to the node point 385′ and onward via a line 424 to a third diode 425, which in turn is connected via a line 426 to the node point 400. The flow direction of the third diode 425 is oriented from the line 426 to the line 424. From the node point 385, a further line 427 extends to a fourth diode 428, which in turn is connected via a line 429 to the node point 404. The flow direction of the fourth diode 428 is oriented from the line 429 to the line 427. From the node point 422, a line 430 leads to a fifth diode 431, which in turn is connected via a line 432 to the node point 408. The fifth diode 431 has a flow direction which leads from the line 432 to the line 430. From the node point 396, a further line 433 extends to a sixth diode 434, which in turn is connected via a line 435 to the node point 412. The sixth diode 434 has a flow direction which extends from the line 435 to the line 444. The balancing circuit 369 is thus complete.

FIG. 2 shows the electrical accumulator 301 and the balancing circuit 369 of FIG. 1 in all their features. Unlike in FIG. 1, the sixth switch 410 is closed for a first method step, and the accumulator group 346 has a higher group voltage than the other accumulator group 333. The result is an electric circuit 437 which is provided with current direction arrows 438 and is shown in heavy lines in FIG. 2. The electric circuit 437 thus includes the fourth accumulator group 346 and extends from the node point 345 via the lines 415 and 405 to the fourth winding 406, as a result of which the corresponding coil 307′ is excited by means of the oncoming current. From the winding 406, the electric circuit 437 extends onward via the lines 407, 409, 411 and 413 to the node point 358, as a result of which the electric circuit 437 with the fourth accumulator group 346 is closed. The closure of the switch 410 is followed by opening of the switch 410, as soon as the winding 408 is sufficiently excited. This opening of the switch 410 can take place after a certain amount of time, or whenever a certain amount of current has flowed through the winding 406.

FIG. 3 shows the electrical accumulator 301 and the balancing circuit 369 of FIG. 1 in all their features. All the switches 373 are opened for a second method step. In contrast to FIG. 1, a situation prevails in which the coil 370′ belonging to the fourth winding 406 is excited. Because of the excitation, a reinduction occurs, which effects a flow of current in the balancing circuit 369. This flow of current leads to an electric circuit 439, which is shown in heavy lines in FIG. 3 and is provided with current direction arrows 438. Thus the electric circuit 439 contains the third accumulator group 333, which is charged by the excited coil 370′ via the electric circuit 439. The electric circuit 439, beginning at the winding 406, contains the lines 407 and 432, which lead to the diode 431. From the diode 431, the electric circuit 439 extends via the lines 430, 423 and 414 to the node point 332, past the accumulator group 333, and from the node point 345 via the lines 415 and 405 back to the winding 406.

FIG. 4 shows the electrical accumulator 301 and the balancing circuit 369 of FIG. 1 in all their features. Unlike in FIG. 1, the fourth switch 394 and the fifth switch 402 are closed for a further, first method step, and the accumulator group 333 has a higher group voltage than the other accumulator group 320 and/or 346. The result is thus an electric circuit which contains both the third accumulator group 33 and the third winding 398. The electric circuit 440 is shown in heavy lines in FIG. 4 and is provided with current direction arrows 438. Thus the electric circuit 440 contains the third accumulator group 333 and extends from the node point 332 via the lines 414, 493 and 395 as well as the line 397 to the third winding 398. The coil 370′ belonging to the third winding 398 is excited by the current flowing through it and then conducts this current onward via the lines 399, 401, 403 and 415 to the node point 345, as a result of which the electric circuit 140 closes to the third accumulator group 333.

FIG. 5 shows the electrical accumulator 301 and the balancing circuit 369 of FIG. 1 in all their features. In contrast to FIG. 1, a situation prevails in which the coil 370′ belonging to the third winding 395 is excited. For a further, second method step, the fifth switch 402 is also closed, while conversely the fourth switch 394 is open. Because of the reinduction of the excited winding 398, a current flow results from which an electric circuit 441 is formed, which is shown in heavy lines in FIG. 5. The direction of the current course is indicated by means of current direction arrows 438. It becomes clear that the charge stored in the winding 398 is loaded into the fourth accumulator group 346 via the electric circuit. The electric circuit 441, beginning at the third winding 398, includes the lines 401, 403 and 415, which leads to the node point 345 of the fourth accumulator group 346. The fourth accumulator group 346 carries the electric circuit 441 onward to the node point 358, which is connected via the lines 413 and 435 to the sixth diode 434, which closes the electric circuit 441 to the third winding 398 via the lines 427 and 386.

FIG. 6 shows the electrical accumulator 301 and the balancing circuit 369 of FIG. 1 with all their features. Unlike in FIG. 1, the fourth switch 394 is closed, and the coil 370′ assigned to the third winding 398 is excited for a further, second method step. Because of the excitation and the attendant reinduction, the result is an electric circuit 442, which loads the charge, stored in the coil 370′, into the second accumulator group 320. The electric circuit 442 is shown in heavy lines in FIG. 6 and is provided with current direction arrows 438. Beginning at the third winding 398, the electric circuit 442 contains the lines 399 and 426, which connect the third winding 398 to the third diode 425. From the third diode 425, the electric circuit 442 extends via the lines 424 and 424′ to the node point 319 of the second accumulator group 390. The second accumulator group 390 extends the electric circuit 442 onward and is connected via the node point 332 to the line 414, which together with the lines 393, 395 and 397 closes the electric circuit 442.

FIGS. 4, 5 and 6 together illustrate the possibility that in the exemplary embodiment shown, first, by the closure of two switches 373, one of the windings 370 can be connected to the accumulator group 390 or in other words charged, and then, by opening of one of the switches 373, a further accumulator group 320 or 346, associated with the corresponding switch 373, can be charged. Thus a simple possibility is created with which selectively a coil 370′ of one accumulator unit 302 can be charged and a certain other accumulator unit 302 can be loaded.

1-14. (canceled)

15. A method for balancing the electrical group voltages of at least two serially connected electrical accumulator groups, each accumulator group having a plurality of accumulator units, comprising the steps of:
connecting a first accumulator group to the winding of a coil for its excitation; and after that, by means of the excited coil, charging a second accumulator group by connection of the winding to the second accumulator group.

16. The method as defined by claim 15, wherein at least one of the accumulator units is discharged via an electrical consumer, in particular an ohmic resistor, for individual voltage balancing.

17. The method as defined by claim 15, wherein the accumulator group having a highest group voltage is connected to the winding of the coil for its excitation.

18. The method as defined by claim 16, wherein the accumulator group having a highest group voltage is connected to the winding of the coil for its excitation.

19. The method as defined by claim 16, wherein the accumulator unit having a highest electrical voltage within its accumulator group is discharged via the electrical consumer for individual voltage balancing.

20. The method as defined by claim 18, wherein the accumulator unit having a highest electrical voltage within its accumulator group is discharged via the electrical consumer for individual voltage balancing.

21. The method as defined by claim 15, wherein as each of the accumulator units, one accumulator cell, in particular one battery cell, is used.

22. The method as defined by claim 18, wherein as each of the accumulator units, one accumulator cell, in particular one battery cell, is used.

23. The method as defined by claim 15, wherein the winding is connected to the first accumulator group for excitation of the coil by means of closure of at least one switch.

24. The method as defined by claim 22, wherein the winding is connected to the first accumulator group for excitation of the coil by means of closure of at least one switch.

25. The method as defined by claim 23, wherein the winding is connected to the second accumulator group by the opening of the switch.

26. The method as defined by claim 15, wherein the second accumulator group is charged by the coil via at least one diode.

27. The method as defined by claim 24, wherein the second accumulator group is charged by the coil via at least one diode.

28. The method as defined by claim 15, wherein a plurality of charged accumulator groups and a plurality of switches are used, and that the excited coil, by means of opening of at least one corresponding switch, charges at least one associated accumulator group.

29. The method as defined by claim 27, wherein a plurality of charged accumulator groups and a plurality of switches are used, and that the excited coil, by means of opening of at least one corresponding switch, charges at least one associated accumulator group.

30. An electrical accumulator having at least two serially connected electrical accumulator groups, each with a plurality of accumulator units, and having an electrical balancing circuit for performing the method as defined by claim 15, the balancing circuit having at least one coil having a winding, the winding of which is connectable to a first accumulator group for excitation of the coil, and for charging a second accumulator group, the winding is connectable to that accumulator group.

31. The accumulator as defined by claim 30, wherein the balancing circuit has at least one diode and/or at least one switch.

32. The accumulator as defined by claim 31, wherein the switch is embodied as a semiconductor switch, in particular a transistor or thyristor.

33. The accumulator as defined by claim 30, wherein the balancing circuit has at least one ohmic resistor for discharging at least one of the accumulator units.

34. The accumulator as defined by claim 30, wherein each of the accumulator units is an accumulator cell, in particular a battery cell.
